(19) United States
(12) Patent Application Publication
(10) Pub. No.: US 2023/0053286 A1
(43) Pub. Date: Feb. 16, 2023

(54) METHOD FOR PRINTING AN OPTICAL COMPONENT WITH TRUE LAYER SLICING

(71) Applicant: LUXEXCEL HOLDING BV., Eindhoven (NL)

(72) Inventor: John-John Van Den Bergh, Eindhoven (NL)

(21) Appl. No.: 17/791,946

(22) PCT Filed: Feb. 26, 2021
(86) PCT No.: PCT/EP2021/054813

§ 371 Date: Jul. 11, 2022

(30) Foreign Application Priority Data
Feb. 28, 2020 (EP) 20160232.3

(51) Int. Cl. B29C 64/393; B33Y 10/00; B33Y 80/00; B33Y 50/02

(52) U.S. Cl. CPC B29C 64/393; B33Y 10/00; B33Y 80/00; B33Y 50/02; B29L 2011/0016

(57) ABSTRACT

A method for printing a three-dimensional optical structure, in particular an ophthalmic lens, wherein the three-dimensional optical structure is built up from layers of printing ink deposited through targeted placement of droplets of printing ink at least partially side by side in consecutive printing steps, wherein a slicing (3) of the three-dimensional structure to be printed is adapted depending on a predefined true layer shape (2) so that during at least one printing step at least one layer is printed depending on the predefined true layer shape (2), wherein the predefined true layer shape (2) comprises the shape and/or volume characteristics of a typical printed layer.

### BACKGROUND

The present invention relates to a method for printing a three-dimensional optical structure, in particular an ophthalmic lens, wherein the three-dimensional optical structure is built up from layers of printing ink deposited through targeted placement of droplets of printing ink at least partially side by side in consecutive printing steps.

Printing three-dimensional optical structures such as ophthalmic lenses is known from the prior art. In three-dimensional printing, a three-dimensional structure is built up from layers of printing ink. The printing data that encode the shape and size of these layers are obtained from a virtual slicing of the three-dimensional structure to be printed into two-dimensional slices. Conventionally, the slices comprise a top surface and a bottom surface that are parallel to each other and a peripheral edge of a defined and usually fixed height. For example, the slices are cylindrical and of varying diameter. For each slice, a layer is deposited through a targeted placement of droplets of printing ink at least partially side by side by the ejection nozzles of a print head. The layers are printed at least partially above each other to form the intended three-dimensional structure.

Due to the surface tension of the deposited printing ink, the actual shape of a printed layer differs from the intended shape of the layer, namely the shape of the corresponding slice. For example, a meniscus may form on the top surface of the deposited layer, in particular along the top edge of the deposited layer. Even though these deviations may be small for a single deposited layer, they do add up and result in a printed structure whose shape differs from the intended shape. Due to the high accuracy required for optical applications, the associated error is particularly detrimental for printed optical structures, in particular ophthalmic lenses.

### SUMMARY

Hence, it is a purpose of the present invention to provide a method for printing three-dimensional optical components, in particular ophthalmic lenses, with an increased accuracy as compared to methods according to the state of the art.

According to the present invention, this object is achieved by a method for printing a three-dimensional optical structure, in particular an ophthalmic lens, wherein the three-dimensional optical structure is built up from layers of printing ink deposited through targeted placement of droplets of printing ink at least partially side by side in consecutive printing steps, characterized in that a slicing of the three-dimensional structure to be printed is adapted depending on a predefined true layer shape so that during at least one printing step at least one layer is printed depending on the predefined true layer shape, wherein the predefined true layer shape comprises the shape and/or volume characteristics of a typical printed layer.

The predefined true layer shape allows to take into account the actual shape of at least one deposited layer. Hence, deviations of the actual printed shape of a deposited layer from the ideal shape of the layer, i.e. the corresponding slice, can be taken into account in the at least one printing step. E.g. due to surface tension, a meniscus forms along the top edge of a deposited layer after deposition, so that excess printing ink forms a rim along the top edge and a depression forms due to lacking printing ink in the center of the deposited layer. By adapting the slicing of the three-dimensional structure to be printed in the printing steps following the at least one printing step n, suchlike deviations between the actual shape of the deposited layer and the ideal shape of the layer can be taken into account. Taking into account the predefined true layer shape through an adaption of the slicing depending on the predefined true layer shape hence allows printing three-dimensional optical structures of increased accuracy.

Optical structures in the sense of the present invention comprise lenses, in particular ophthalmic lenses. Ophthalmic lenses comprise concave, convex, biconcave, biconvex and meniscus lenses. Ophthalmic lenses in the sense of the present invention also comprise multifocal lenses as well as gradient-index lenses. Ophthalmic lenses comprise in particular spectacle lenses or other lenses that are not inserted into the eye.

In the sense of the present invention, printing of an optical component comprises building up the component from layers of printing ink. These are obtained through a targeted placement of droplets of printing ink at least partially side by side. The droplets of printing ink are ejected from the nozzles of a print head, typically towards a substrate. Droplets of layers constituting the second and following layers are at least partly ejected towards the previously deposited layer, such that the three-dimensional structure is built up layer by layer.

The printing ink preferably comprises a translucent or transparent component. Preferably, the printing ink comprises at least one photo-polymerizable component. The at least one photo-polymerizable component is preferably a monomer that polymerizes upon exposure to radiation, e.g. ultra-violet (UV) light. The deposited droplets are preferably pin cured, i.e. partially cured, after deposition. Preferably, the viscosity of at least one component of the printing ink is increased. Pin curing is preferably carried out after deposition of the respective droplet or after deposition of an entire or only part of a layer. Alternatively, pin curing is carried out at certain intervals, e.g. after printing of every second layer.

The shape and volume of the layers are defined through a virtual slicing of the three-dimensional structure to be printed. Virtual slicing comprises the approximation of the intended shape into a stack of two-dimensional slices. The slices have a defined height h.

Preferably, the height h of all slices is equal, e.g. defined by the volume of droplets ejected by the print head in use. Alternatively or additionally, the height h is defined by the aspired printing time and/or the aspired accuracy. Preferably, the slices have a flat top and a bottom surface, which are identical to each other. Particularly preferably, the slices are parallel to each other and do not intersect. For example, the slices are of cylindrical shape and are of varying diameter.

A typical printed layer in the sense of the present invention is an average layer deposited by a specific printer, depending on the print head and printing ink used. The typical printed layer can also depend on the ejection nozzles of the print head, the volume of ejected droplets, the printing speed and other printer settings. The volume characteristics describe the volume distribution of the typical printed layer. It contains information on the deposited volume of printing ink. The shape characteristics describe the shape, e.g. the height distribution, of the typical printed layer. It contains, for example, the information on the height distribution of the deposited printing ink. The volume and/or shape characteristics are e.g. a function of the two-dimensional printing plane.

According to a preferred embodiment of the present invention, the predefined true layer shape is determined in a calibration step prior to the at least one printing step. Hence, the predefined true layer shape can be determined once for a specific printer and/or printing ink and/or printer settings. This information can then be used to improve every print carried out with this printer, printing ink and/or printer settings.

According to a preferred embodiment, determining the predefined true layer shape comprises printing at least one calibration layer and measuring the shape and/or volume of the at least one calibration layer at least once during the calibration step. Preferably, determining the predefined true layer shape comprises fitting multiple measured shapes to a predefined shape function and/or fitting multiple measured volumes to a predefined volume function during the calibration step. Through repeated measurements, the measurement errors can be reduced and the statistics improved. Shape and/or volume characteristics of a typical printed layer, i.e. an average layer printed with a specific printer, printing ink and/or printer settings, can be easily and reliably determined, captured and stored.

In a preferred embodiment, the shape and/or volume of the at least one calibration layer are determined through an area measurement during the calibration step. Hence, a complete surface profile of the calibration layer is obtained. Through repeated measurement and averaging, an average surface profile of a typical printed layer can be determined.

Alternatively or additionally, the shape and/or volume of the at least one calibration layer are determined through a line measurement during the calibration step. This is particularly useful for layers which have an axis of symmetry in the printing plane, e.g. circular layers used when printing ophthalmic lenses. It is also conceivable that multiple line measurements at defined angles are carried out. E.g. the first line measurement is orthogonal to the second line measurement.

According to a preferred embodiment, the at least one layer is printed during the at least one printing step depending on a feedforward of the predefined true layer shape. The predefined true layer shape advantageously provides information on the layer deposited in a printing step prior to the at least one printing step. According to an alternative embodiment, the at least one layer is printed during the at least one printing step depending on a feedback of the predefined true layer shape. The predefined true layer shape advantageously provides information on the at least one layer deposited during the at least one printing step. The feedforward or feedback of the predefined true layer shape allows to take into account the actual shape of the deposited layer, albeit in an approximate way.

In a preferred embodiment, the height and/or shape of the slice corresponding to the at least one layer is adapted depending on the predefined layer shape. Preferably, the height and/or shape of the slice corresponding to the at least one layer is adapted during the at least one printing step.

According to a preferred embodiment, the at least one layer is printed depending on a virtual slicing of the remaining structure to be printed, wherein the remaining structure to be printed is determined by the difference of the full three-dimensional optical structure and the structure printed during the printing steps preceding the at least one printing step. According to a preferred embodiment, the structure printed during the printing steps preceding the at least one printing step is determined using the predefined true layer shape. Hence, instead of an ideal layer defined by the slicing, the actual shape of the deposited layer is taken into account in the form of the predefined true layer shape. Hence, the remaining structure to be printed is determined taking into account the actual shape and/or volume distribution of printing ink deposited during the printing steps preceding the at least one printing step.

Preferably, the at least one printing step is the n-th printing step and the remaining structure to be printed is determined as the difference between the remaining structure to be printed of the (n−1)-th printing step and the predefined true layer shape, wherein n>1. Particularly preferably, this procedure is carried out repeatedly, e.g. for all printing steps following the first printing step. As the structure printed during the printing steps preceding the at least one printing step is determined from the predefined true layer shape, its shape and/or volume is the actual shape and/or volume deposited during preceding printing steps. The slice defining the at least one layer is obtained from a slicing of the true remaining structure to be printed. Hence, an accumulation of errors from a deformation of the deposited layers, e.g. through surface tension and viscosity effects, is prevented. More than that, these deformations are taken into account in the slicing of the remaining structure to be printed. The thus enhanced slicing hence compensates for the deformation of the deposited layers.

### BRIEF DESCRIPTION OF THE DRAWINGS

FIG. 1 schematically illustrates a printing method according to an exemplary embodiment of the present invention.

FIG. 2 schematically illustrates the calibration step according to an exemplary embodiment of the present invention.

FIG. 3 schematically illustrates a printing method according to an exemplary embodiment of the present invention.

### DETAILED DESCRIPTION

The present invention will be described with respect to particular embodiments and with target to certain drawings but the invention is not limited thereto but only by the claims. The drawings described are only schematic and are non-limiting. In the drawings, the size of some of the elements may be exaggerated and for illustrative purposes may not be drawn to scale.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

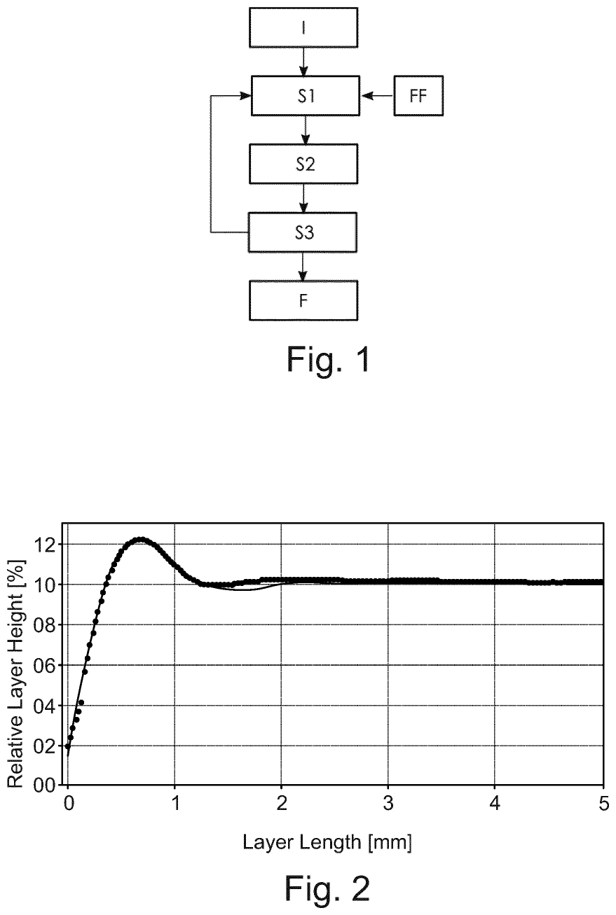

In FIG. 1, a printing method according to an exemplary embodiment of the present invention is schematically illustrated.

According to the state of the art, a three-dimensional structure 1 is virtually sliced into two-dimensional slices. For each of these slices, a layer of printing ink is deposited from the ejection nozzles of a print head of an inkjet printer. Due to the surface tension of the deposited printing ink, the shape of the deposited layer differs from the intended shape defined by the corresponding slice. When printing ophthalmic lenses, for example, the slices are of a cylindrical shape with a top and bottom surface which are flat and parallel to each other. Due to surface tension and viscosity effects, the top surface of the corresponding deposited layer is not flat, however. Generally, a meniscus forms along the edge of the top surface of the deposited layer. Hence, excess printing ink accumulates along the top edge of the layer, forming a ring shaped protrusion on the top surface. This protrusion is accompanied by a ring shaped depression with only an insufficient amount of printing ink. If not accounted for, these deviations accumulate resulting in an error prone three-dimensional optical structure.

In order to account for these deviations, the method according to the present invention takes into account the true layer shape, i.e. the actual shape of the deposited layers during the printing process, during at least one printing step. The true layer shape is provided in the form of a predefined true layer shape comprising the shape and/or volume characteristics of a typical printed layer. The typical printed layer is specific for a specific printer, printing ink and/or printer settings. It comprises the shape and/or volume characteristics of an average layer of the specific printing ink deposited with the specific printer with the specific printer settings. Preferably, the predefined true layer shape is obtained during a calibration step prior to the at least one printing step, see FIG. 2. During the calibration step, a calibration layer is deposited and the shape and/or volume of the calibration layer is determined at least once. Preferably, multiple calibration layers are deposited and their volume and/or shape measured and averaged, respectively. Particularly preferably, the measured volume or, in case of multiple measurements, the averaged volume is fitted to a predefined volume function. Alternatively or additionally, the measured shape or, in case of multiple measurements, the averaged shape is fitted to a predefined shape function. The shape and/or volume are determined through a two-dimensional measurement. Alternatively, the shape and/or volume are determined through one or multiple one-dimensional, i.e. line, measurements. Line measurements are time and cost saving and particularly suitable for slices with at least one axis of symmetry in the printing plane. For a cylindrical slice as used in printing ophthalmic lenses, a one-dimensional lines measurement suffices to capture the volume and/or shape characteristics of the typical printed layer. In the example depicted in FIG. 2, shape is determined through height measurements of the at least one calibration layer. The height profile can, for example, be determined through confocal height measurements. Here, confocal height measurements of ten calibration layers are carried out and averaged to obtain a height profile of a typical printed layer. As can be inferred from the averaged relative layer height (dotted line), the typical printed layer is not flat. In particular, the top surface of the typical printed layer is non-flat. A protrusion and a neighboring depression forms due to surface tension and viscosity effects. The averaged shape given by the height profile is fitted to a predefined shape function (solid line). The predefined shape function is, for example

$$f ( x ) = 1 - {e}^{- ax} \cdot \frac{sin ( bx + c )}{sin ( c )}$$

Here, a, b, c define the parameters to be fitted. The variable x describes the length along a diameter of the calibration layer. A predefined shape and/or volume function allows a compact and efficient means to determine, capture and store the shape and/or volume characteristics of a typical printed layer. The predefined true layer shape is then, for example, provided in the form of the fitted predefined shape function and/or in the form of the fitted predefined volume function. Alternatively, the shape and/or volume characteristics are provided in the form of a lookup table.

According to the present invention, the three-dimensional optical structure is built up from layers of printing ink deposited through targeted placement of droplets of printing ink at least partially side by side in consecutive printing steps. At least one layer is printed during the corresponding at least one printing step depending on the predefined true layer shape determined during the calibration step as described above. The predefined true layer shape is e.g. provided in the at least one printing step either by a feedforward or a feedback of the corresponding shape and/or volume function. Preferably, the slicing of the structure to be printed during the at least one printing step is adapted depending on the predefined true layer shape. For example, the height and/or shape of the slice corresponding to the at least one layer is adapted during the at least one printing step.

Preferably, the predefined true layer shape is used to adapt the slicing of multiple layers during the respective printing steps. For example, after an initialization step I during which the initial layers are printed, the predefined true layer shape is provided during at least one printing step through a feedforward FF. The at least one printing step is the n-th printing step, e.g. n=2.

During the at least one printing step, three substeps S1, S2 and S3 are carried out. First, the remaining structure R to be printed is determined in a substep S1. The remaining structure Rₙ to be printed in the n-th printing step is obtained as the difference of the remaining structure Rₙ₋₁ to be printed in the (n−1)-th printing step and the previously deposited layer.

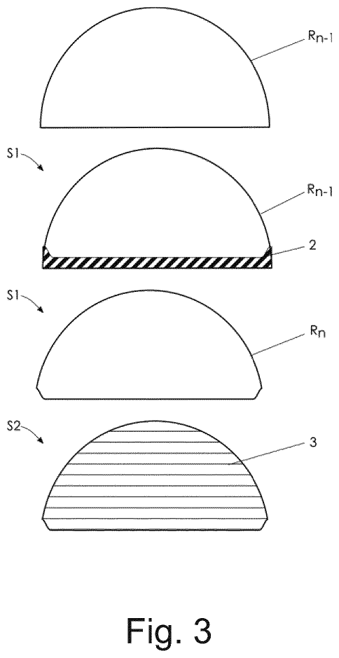

The previously deposited layer is taken into account in the form of the predefined true layer shape 2, as depicted in FIG. 3. From the remaining structure Rₙ₋₁ the predefined true layer shape 2 is subtracted. Hence, the remaining structure Rₙ is obtained. The remaining structure Rₙ is virtually sliced into two-dimensional slices 3 providing the printing data for the n-th printing step. This is done during the true-layer slicing substep S2 of the at least one printing step. Actual printing of the at least one layer is carried out during the substep S3 of the at least one printing step. The layer corresponding to the lowest slice obtained from the true-layer slicing 3 is deposited during the substep S3. Preferably, substeps S1-S3 are repeated for multiple layers. Particularly preferably, substeps S1-S3 are repeated until the three-dimensional optical structure 1 is finished. Substeps S1-S3 are optionally followed by the finalizing step F. The finalizing step F comprises, for example, conventional printing of the remaining layers that need to be printed to finish the three-dimensional optical structure 1 in case not all layers are printed using the true layer slicing 3 and the predefined true layer shape 2. The finalizing step F can also comprise edging, surfacing, coating and other methods needed to finalize the printed three-dimensional optical structure 1.

KEY TO FIGS.
1 Three-dimensional optical structure
2 Predefined true layer shape
3 True layer slicing
I Initialization step
S1 Determination of remaining structure to be printed
S2 True-layer slicing
S3 Printing step
FF Feedforward of true layer shape
F Finalizing step
Rₙ Remaining structure to be printed (n-th printing step)
n Number of printing step

1. A method for printing a three-dimensional optical structure, comprising:
building the three-dimensional optical structure from layers of printing ink deposited through targeted placement of droplets of printing ink at least partially side by side in consecutive printing steps; and
adapting a slicing of the three-dimensional optical structure to be printed depending on a predefined true layer shape so that during at least one printing step n at least one layer is printed depending on the predefined true layer shape;
wherein the predefined true layer shape comprises shape and/or volume characteristics of a typical printed layer.
wherein the typical printed layer is an average layer deposited by a specific printer, depending on a print head and printing ink used;
wherein the predefined true layer shape is determined in a calibration step prior to the at least one printing step n;
wherein determining the predefined true layer shape comprises printing at least one calibration layer and measuring a shape and/or volume of the at least one calibration layer at least once during the calibration step;
wherein multiple calibration layers are deposited and their volume and/or shape are measured and averaged, respectively.

2. (canceled)

3. (canceled)

4. (canceled)

5. The method according to claim 1, wherein the shape and/or volume of the at least one calibration layer are determined through an area measurement during the calibration step.

6. The method according to claim 1, wherein the shape and/or volume of the at least one calibration layer are determined through a line measurement during the calibration step.

7. The method according to claim 1, wherein the at least one layer is printed during the at least one printing step n depending on a feedforward of the predefined true layer shape.

8. The method according to claim 1, wherein the at least one layer is printed during the at least one printing step n depending on a feedback of the predefined true layer shape.

9. The method according to claim 1, wherein a height and/or shape of a slice corresponding to the at least one layer is adapted depending on the predefined true layer shape.

10. The method according to claim 9, wherein the height and/or shape of the slice corresponding to the at least one layer is adapted during the at least one printing step n.

11. The method according to claim 1, wherein the at least one layer is printed depending on a virtual slicing of a remaining structure Rₙ to be printed, wherein the remaining structure Rₙ to be printed is determined by a difference of the full three-dimensional optical structure and a structure printed during the printing steps preceding the at least one printing step.

12. The method according to claim 11, wherein the structure printed during the printing steps preceding the at least one printing step n is determined using the predefined true layer shape.

13. The method according to claim 12, wherein the at least one printing step n is the n-th printing step and the remaining structure Rₙ to be printed is determined as the difference between a remaining structure Rₙ₋₁ to be printed of an (n−1)-th printing step and the predefined true layer shape, wherein n>1.

14. The method according to claim 6, wherein multiple line measurements at defined angles are carried out.

15. The method according to claim 5, wherein a height and/or shape of a slice corresponding to the at least one layer is adapted depending on the predefined true layer shape.

16. The method according to claim 15, wherein the at least one layer is printed depending on a virtual slicing of a remaining structure Rₙ to be printed, wherein the remaining structure Rₙ to be printed is determined by a difference of the full three-dimensional optical structure and a structure printed during the printing steps preceding the at least one printing step.

17. The method according to claim 16, wherein the structure printed during the printing steps preceding the at least one printing step n is determined using the predefined true layer shape.

18. The method according to claim 17, wherein the at least one printing step n is the n-th printing step and the remaining structure Rₙ to be printed is determined as the difference between a remaining structure Rₙ₋₁ to be printed of an (n−1)-th printing step and the predefined true layer shape, wherein n>1.

19. The method according to claim 6, wherein a height and/or shape of a slice corresponding to the at least one layer is adapted depending on the predefined true layer shape.

20. The method according to claim 19, wherein the at least one layer is printed depending on a virtual slicing of a remaining structure Rₙ to be printed, wherein the remaining structure Rₙ to be printed is determined by a difference of the full three-dimensional optical structure and a structure printed during the printing steps preceding the at least one printing step.

21. The method according to claim 20, wherein the structure printed during the printing steps preceding the at least one printing step n is determined using the predefined true layer shape.

22. The method according to claim 21, wherein the at least one printing step n is the n-th printing step and the remaining structure Rₙ to be printed is determined as the difference between a remaining structure Rₙ₋₁ to be printed of an (n−1)-th printing step and the predefined true layer shape, wherein n>1.

23. The method according to claim 19, wherein multiple line measurements at defined angles are carried out.
